(19) United States
(12) Patent Application Publication
(10) Pub. No.: US 2016/0173322 A1
(43) Pub. Date: Jun. 16, 2016

(54) METHODOLOGY FOR RE-ESTABLISHING COMMUNICATION, NAVIGATION, AND POWER LINKS IN A MARINE ENVIRONMENT

(71) Applicant: THE BOEING COMPANY, Chicago, IL (US)

(72) Inventors: William J. Purpura, Chicago, IL (US); William P. Austell, Chicago, IL (US)

(21) Appl. No.: 14/567,919

(22) Filed: Dec. 11, 2014

(51) Int. Cl. H04L 12/24; H04B 10/80; H04B 1/3822; H04W 76/02; B63B 22/00; B63B 22/18

(52) U.S. Cl. CPC H04L 41/0654; B63B 22/00; B63B 22/18; H04B 1/3822; H04W 76/028; H04B 10/80

(57) ABSTRACT

Systems, methods, and apparatus for re-establishing at least one link to a vehicle are disclosed. In one or more embodiments, the disclosed method involves transmitting, by a control station, a deployment control signal to a deployment device located underwater. The method further involves receiving, by the deployment device, the deployment control signal. Also, the method involves deploying, by the deployment device, the buoy device from a first position to a second position located above the first position upon receipt of the deployment control signal by the deployment device. In addition, the method involves transmitting and/or receiving, by the control station, at least one first linking signal to the buoy device. Further, the method involves transmitting and/or receiving, by the buoy device, at least one second linking signal to the vehicle to re-establish the at least one link.

### FIELD

The present disclosure relates to re-establishing links. In particular, it relates to a methodology for re-establishing communication, navigation, and power links in a marine environment.

### BACKGROUND

Future opponents may target command and control systems (e.g., battle management command and control (BMC2) systems) aboard vehicles (e.g., warships) via various attack modes to destroy communication links, navigation links (e.g., time synchronization links), and/or power links. Examples of various attack modes include, but are not limited to (1) electromagnetic interference (EMI) attacks, which are used to interrupt, obstruct, or otherwise degrade/eliminate internet protocol (IP) communication links and/or navigation links; (2) cyber based attacks, which are digital assaults over IP communication links and navigation links on networks, nodes, and systems to disrupt capabilities, gather/plant data, and take control of systems; and (3) kinetic attacks, which are traditional attacks to physically destroy IP communication links, navigation links, power links, and/or BMC2 assets (e.g., land, air, sea, and space vehicle systems), and networked operational assets (e.g., control station systems).

As such, there is a need for a technique for re-establishing navigation, communication, and power links that are destroyed.

### SUMMARY

The present disclosure relates to a method, system, and apparatus for re-establishing communication, navigation, and power links in a marine environment. In one or more embodiments, a method for re-establishing at least one link to a vehicle involves transmitting, by a control station, a deployment control signal to a deployment device located underwater. The method further involves receiving, by the deployment device, the deployment control signal. Also, the method involves deploying, by the deployment device, the buoy device from a first position to a second position located above the first position upon receipt of the deployment control signal by the deployment device. In addition, the method involves transmitting and/or receiving, by the control station, at least one first linking signal to the buoy device. Further, the method involves transmitting and/or receiving, by the buoy device, at least one second linking signal to the vehicle to re-establish at least one link.

In one or more embodiments, the deployment control signal is transmitted by a wire and/or wirelessly.

In at least one embodiment, the second position is located underwater and/or above water.

In one or more embodiments, the vehicle a marine vehicle, an airborne vehicle, or a terrestrial vehicle.

In at least one embodiment, at least one first linking signal is a radio frequency (RF) signal, an infrared (IR) signal, an optical signal, and/or a power signal. In some embodiments, at least one second linking signal is a radio frequency (RF) signal, an infrared (IR) signal, an optical signal, and/or a power signal.

In one or more embodiments, at least one first linking signal is transmitted and/or received by the control station by a wire and/or wirelessly. In some embodiments, at least one second linking signal is transmitted and/or received by the buoy device by a wire and/or wirelessly.

In at least one embodiment, at least one link is a communication link, a time synchronization link, and/or a power link. In some embodiments, the time synchronization link is a global positioning system (GPS) link.

In one or more embodiments, the method further involves activating, by the buoy device, at least one locator indicator. In some embodiments, at least one locator indicator is a visual indicator, an audio indicator, and/or a communication signal indicator.

In at least one embodiment, a system for re-establishing at least one link to a vehicle involves a control station to transmit a deployment control signal to a deployment device located underwater, and to transmit and/or receive at least one first linking signal to a buoy device. The system further involves the deployment device to receive the deployment control signal, and to deploy the buoy device from a first position to a second position located above the first position upon receipt of the deployment control signal by the deployment device. Further, the system involves the buoy device to transmit and/or receive at least one second linking signal to the vehicle to re-establish at least one link.

In one or more embodiments, an apparatus for re-establishing at least one link to a vehicle involves a buoy device comprising at least one antenna. In one or more embodiments, the buoy device is to deploy from a first position underwater to a second position located above the first position; and to transmit and/or receive at least one linking signal to the vehicle to re-establish at least one link.

The features, functions, and advantages can be achieved independently in various embodiments of the present disclosure or may be combined in yet other embodiments.

### DRAWINGS

These and other features, aspects, and advantages of the present disclosure will become better understood with regard to the following description, appended claims, and accompanying drawings where:

FIG. 1A is a diagram showing the disclosed apparatus for re-establishing communication, navigation, and power links in a marine environment, in accordance with at least one embodiment of the present disclosure.

FIG. 1B is a top view of the disclosed apparatus for re-establishing communication, navigation, and power links in a marine environment of FIG. 1A, in accordance with at least one embodiment of the present disclosure.

FIG. 2 is a diagram illustrating the deployment mechanism for the disclosed apparatus for re-establishing communication, navigation, and power links in a marine environment of FIG. 1A, in accordance with at least one embodiment of the present disclosure.

FIG. 3 is a diagram showing various exemplary means for installation of the disclosed apparatus for re-establishing communication, navigation, and power links in a marine environment of FIG. 1A, in accordance with at least one embodiment of the present disclosure.

FIG. 4 is a block diagram illustrating the disclosed system for re-establishing navigation links in a marine environment, in accordance with at least one embodiment of the present disclosure.

FIG. 5 is a diagram illustrating an overview of the operation of the disclosed system for re-establishing communication, navigation, and power links in a marine environment, in accordance with at least one embodiment of the present disclosure.

FIG. 6 depicts a flow chart depicting the disclosed method for re-establishing communication, navigation, and power links in a marine environment, in accordance with at least one embodiment of the present disclosure.

### DESCRIPTION

The methods and apparatus disclosed herein provide an operative system for re-establishing communication, navigation, and power links in a marine environment. The disclosed system employs a remotely operated, buoy device that is tethered to underwater power cables and/or communication cables. After the buoy device is deployed towards the surface of the water, the buoy device will transmit and/or receive signals to a vehicle for re-establishment of communication, navigation, and/or power links to the vehicle.

As previously mentioned above, future opponents may target command and control systems (e.g., battle management command and control (BMC2) systems) aboard vehicles (e.g., warships) via various attack modes to destroy communication links, navigation links (e.g., time synchronization links), and/or power links. Examples of various attack modes include, but are not limited to (1) electromagnetic interference (EMI) attacks, which are used to interrupt, obstruct, or otherwise degrade/eliminate internet protocol (IP) communication links and/or navigation links; (2) cyber based attacks, which are digital assaults over IP communication links and navigation links on networks, nodes, and systems to disrupt capabilities, gather/plant data, and take control of systems; and (3) kinetic attacks, which are traditional attacks to physically destroy IP communication links, navigation links, power links, and/or BMC2 assets (e.g., land, air, sea, and space vehicle systems), and networked operational assets (e.g., control/command station systems). The disclosed system mitigates impacts to networked communication links and systems by (1) restoring lost wireless IP communication link availability/interoperability due to blockage, destruction, or degradation of technology regardless of the technology used (e.g., RF, satellite, laser, microwave, hardwired, or sonic); (2) restoring blocked navigation signals (e.g., global positioning system (GPS) signals) (e.g., navigation signals used for mission execution/weapon targeting) that are unavailable due to disruption, spoofing, or destruction; and (3) restoring time synchronization signals (e.g., GPS or other external time synchronization signals) (e.g., signals used for real time data exchange and system coordination) that have denied/blocked access.

The system of the present disclosure has several capabilities, which are: (1) the system enables regeneration of lost/degraded IP communication links within anti-access/area-denial (A2D2) environments to reestablish a minimum level of control by control/command centers outside of the contested environments, (2) the system integrates with semi-automated, self-healing/self-optimizing courses of actions that are activated when IP communication loss is detected, (3) the system resumes sufficient data flow to allow for command structure re-configuration sufficient to re-establish an operational command system (e.g., a BMC2 system), and (4) the system supports creation of more/new distributed command centers to assume management of nodes previously under central command.

The disclosed system utilizes various means for re-establishing the lost/degraded links including, but not limited to, (1) using existing IP communication over power technology to re-establish links to land facilities or other local assets still retaining IP network communications to outside systems; (2) piggy backing onto existing/planned underwater power/sensor cables or inserting into contested environments and connecting to freshly laid power/data lines; and (3) integrating with third generation network centric operations (NCO) architectures incorporating semi-automated self-healing and self optimization courses of actions (COA) and automatically activating when main network's IP communication loss is detected.

The disclosed system of the present disclosure supports multiple communication and navigation link technologies including, but not limited to, radio frequency (RF) communications, laser communications (e.g., via air to air, air to water, and below water), ultra low frequency (ULF) communications, Ethernet links, BLUETOOTH links, and acoustic communications.

In addition, the disclosed buoy device may draw standby and operational power from existing/future underwater sensor/power grids, and may include a constantly changing battery storage. The present disclosure may enable a communication restoration system to maintain some capability if a power line is cut, and may provide a power surge to extend the transmission range for short periods, if required, to broadcast through increased jamming or to support additional nodes just out of range.

The present disclosure also provides a design for a multi-deployment autonomous device (e.g., a buoy device) to restore network time synchronization and/or GPS signals in A2D2 environments. The present disclosure has the following capabilities: (1) it provides emergency recovery beacons to restore lost access to real time network-to-network real time synchronization timing as well as jammed or degraded GPS navigation signals that occur within an A2D2 environment; (2) it is used to re-establish local BMC2 systems by re-establishing network-to-network connectivity via the buoy device's direct connection to a reference time synchronization signal for its use of a self-maintained time synchronization signal previously calibrated to the original time reference; and (3) it provides replacement GPS signals, via encrypted short range IP communication links, to broadcast harmonized GPS signals sourced from outside or self-generated pseudo-GPS signals based on a pre-calibrated inertial measurement unit and Kalman filter (with or without tethering to a pre-surveyed location) to restore GPS based attack/defense capabilities sufficiently to meet mission requirements.

In the following description, numerous details are set forth in order to provide a more thorough description of the system. It will be apparent, however, to one skilled in the art, that the disclosed system may be practiced without these specific details. In the other instances, well known features have not been described in detail so as not to unnecessarily obscure the system.

Embodiments of the present disclosure may be described herein in terms of functional and/or logical components and various processing steps. It should be appreciated that such components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with, and that the system described herein is merely one example embodiment of the present disclosure.

For the sake of brevity, conventional techniques and components related to buoy devices, and other functional aspects of the system (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

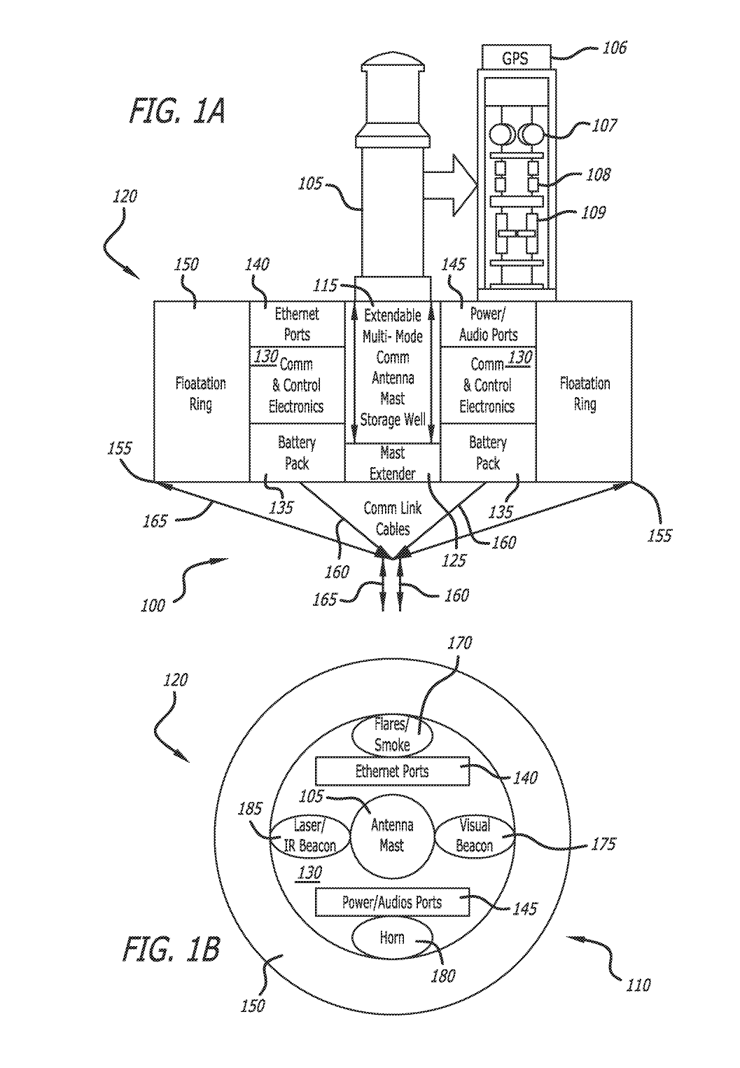

FIG. 1A is a diagram 100 showing the disclosed apparatus (i.e. a buoy device) 120 for re-establishing communication, navigation, and power links in a marine environment, in accordance with at least one embodiment of the present disclosure. In this figure, a buoy device (i.e. the apparatus) 120 is shown to include an extendable multi-mode communication antenna mast 105, an antenna mast storage well 115, and an antenna mast extender unit 125. The antenna mast 105 is initially stored (e.g., housed) within the mast storage well 115. To deploy the antenna mast 105, the antenna mast extender unit 125 will actuate (e.g., move and/or push) the antenna mast 105 up through the mast storage well 115 such that the antenna mast 105 is located external and above the buoy device 120, as is shown in FIG. 1A.

The antenna mast 105 is shown in this figure to contain various different types of antennas, such as a GPS antenna 106, an omni-directional antenna with a frequency band of 2 to 18 GHz, a Vivaldi horn with a frequency band of 700 to 3000 MHz, and a dipole array with a frequency band of 100 to 700 MHz. However, it should be noted that the antenna mast 105 may employ different types of antennas than as shown in FIG. 1A. Types of antennas that the antenna mast 105 may employ include, but are not limited to, various different radio frequency (RF) antennas, infrared (IR) antennas, ultra low frequency (ULF) antennas, and lasers (i.e. optical signals).

Also shown in this figure, surrounding the antenna mast storage well 115 are communication and control electronics 130, which are used for transmitting (e.g., by a transmitter) and receiving (e.g., by a receiver) at least one communication signal to and from the antenna mast 105 for re-establishing at least one communication link, and for controlling (e.g., by at least one processor) the antenna mast extender unit 125. As such, the communication and control electronics 130 may comprise various different types of electronics including, but not limited to, a transmitter, a receiver, and at least one processor, which can be used to control the antenna mast extender unit 125. Also shown surrounding the antenna mast storage well 115 is a battery pack 135, which can be used to power the buoy device 120.

In addition, Ethernet ports 140 are shown to surround the antenna mast storage well 115. After deployment of the buoy device 120, a vehicle may connect, via at least one wire, to the Ethernet ports 140 to re-establish at least one Ethernet communication link. Additionally, power/audio ports 145 are shown to surround the antenna mast storage well 115. In some embodiments, after deployment of the buoy device 120, a vehicle may connect, via at least one wire, to the power ports 145 and/or to the audio ports 145 to re-establish at least one power link and/or at least one audio communication link.

Also shown in this figure, a flotation ring 150 is shown to surround the communication and control electronics 130. The flotation ring 150 is used to allow for the buoy device 120 to rise up towards the surface of the water upon deployment, and to continue to float at the surface of the water.

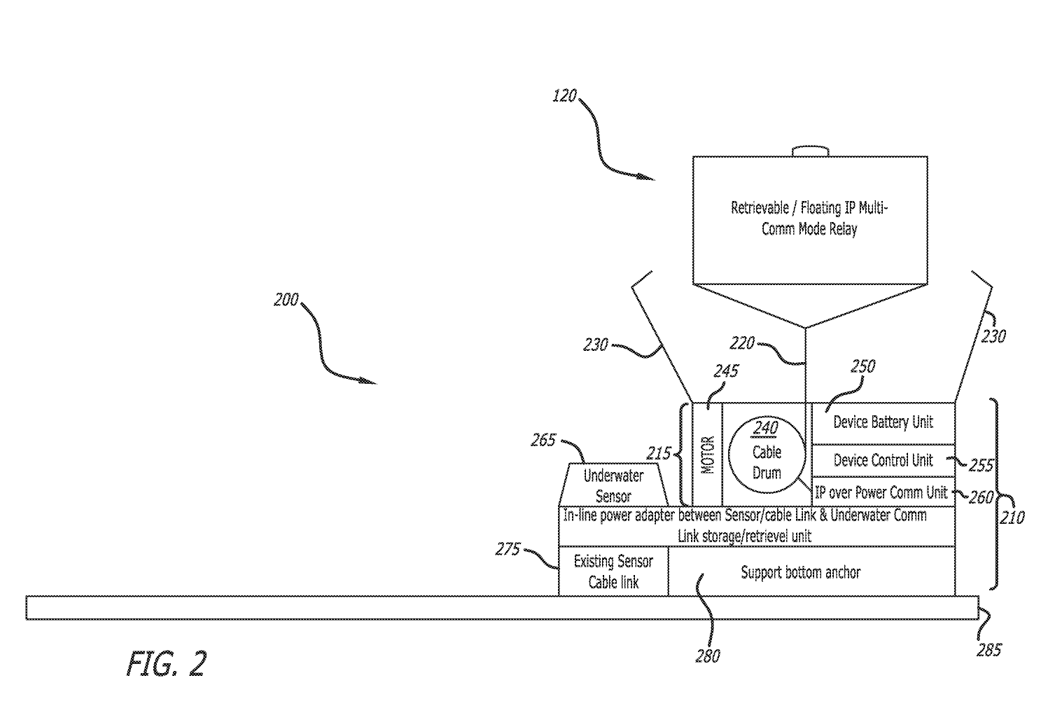

Additionally, an integrated communication umbilical cable 160 is shown to be connected to the buoy device 120. The integrated communication umbilical cable 160 provides communication access and/or power to the buoy device 120. A tethering/retrieval cable 165 is also shown to be connected to the buoy device 120 at anchor points 155 on the buoy device 120. The tethering/retrieval cable 165 is used to tether the buoy device 120 to an underwater deployment device (not shown; refer to FIG. 2), and to release the buoy device 120 from its initial position underwater to its deployed position located above the initial position, and to retrieve the buoy device 120 from its deployed position back to its initial position.

FIG. 1B is a top view 110 of the disclosed apparatus (i.e. buoy device) 120 for re-establishing communication, navigation, and power links in a marine environment of FIG. 1A, in accordance with at least one embodiment of the present disclosure. In this figure, the buoy device 120 is shown to also include a variety of additional devices that can be activated by the buoy device 120, and used to assist in locating the buoy device 120 after its deployment towards the surface of the water. The additional devices include visual indicator devices (e.g., a flares and/or smoke device 170 and a visual beacon 175 (e.g., a light)), an audio indicator device (e.g., a horn 180), and a communication signal indicator device (e.g., a laser and/or IR beacon 185).

FIG. 2 is a diagram 200 illustrating the deployment mechanism for the disclosed apparatus (i.e. buoy device) 120 for re-establishing communication, navigation, and power links in a marine environment of FIG. 1A, in accordance with at least one embodiment of the present disclosure. In this figure, the buoy device 120 is shown to be attached via a cable 220 to an underwater deployment device 210. The cable 220 is wound onto a cable drum 240 of the underwater deployment device 210. The cable 220 is used to provide communication signals, navigation signals (i.e. time synchronization signals), and/or power to the buoy device 120.

When the buoy device 120 is an in stowed position, the buoy device 120 is locked onto (i.e. on top of) the underwater deployment device by locking retention brackets 230 closing down onto the sides of the buoy device 120 to secure it in place. When the buoy device 120 is deployed, the locking retention brackets 230 are opened and the buoy device 120 rises (i.e. floats) towards the surface of the water by use of its flotation ring 150 (refer to FIG. 1B). For retrieval of the buoy device 120, the cable drum 240 of the underwater deployment device 210 retrieves the buoy device 120 back to its stowed position from its deployed position by winding the cable 220 back onto the cable drum 240 and, then, the locking retention brackets 230 close down onto the sides of the buoy device 120 to secure it in place.

Also in this figure, the underwater deployment device 210 is shown to include an underwater communication link storage/retrieval unit 215. The underwater communication link storage/retrieval unit 215 is shown to include, the cable drum 240; a motor 245, which is used to actuate the cable drum 240; a device battery unit 250, which is used to power the underwater deployment device 210; a device control unit 255, which contains at least one processor to control underwater deployment device 210; and an IP communication power over communication unit 260, which is used to provide communications and/or power to the buoy device 120.

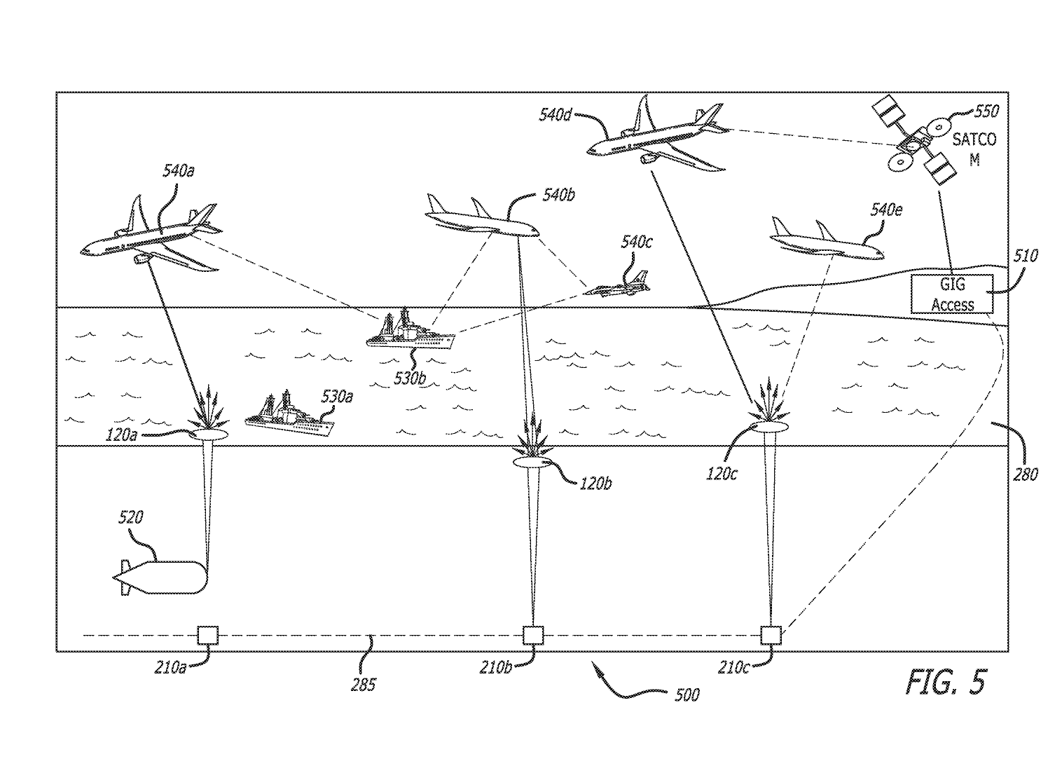

Also shown in this figure is an existing underwater cable 285, which routes power, communication signals, and/or navigation signals to the buoy device 120 from a land facility (refer to the land facility 510 of FIG. 5). Also shown is a support bottom anchor 280, which is used to anchor the underwater deployment device 210 to the existing underwater cable 282. An existing sensor cable link 275 is used to communicate communication signals and/or navigation signals between the existing underwater cable 285 and the underwater deployment device 210, and/or is used to send power from the existing underwater cable 285 to the underwater deployment device 210.

The underwater deployment device 210 also includes an underwater sensor 265 for sensing water depth; and an in-line power adaptor 270 between the existing sensor cable link 275 and the underwater communication link storage retrieval unit 215.

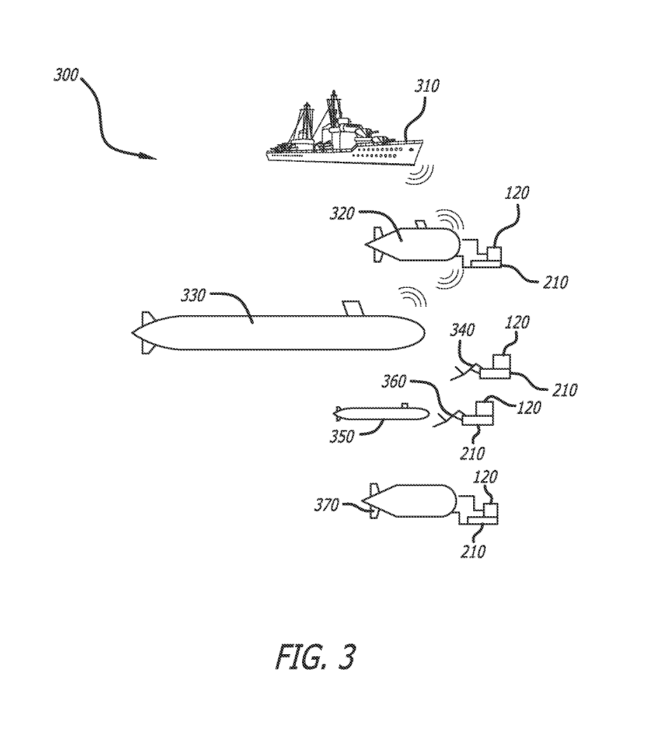

FIG. 3 is a diagram 300 showing various exemplary means for installation of the disclosed apparatus (i.e. buoy device) 120 for re-establishing communication, navigation, and power links in a marine environment of FIG. 1A, in accordance with at least one embodiment of the present disclosure. In this figure, several means for installation of the buoy device 120 stowed within the underwater deployment device 210 are shown. A first means of installation involves the use of a surface controlled (e.g., controlled by a ship 310), large unmanned underwater vehicle (LUUV) 320. The ship 310 remotely controls the LUUV 320 to install the buoy device 120 stowed within the underwater deployment device 210 at a particular location on the existing underwater cable 285 (refer to FIG. 2).

A second means for installation involves a submarine 330 controlled LUUV 320 installation. For this means, the submarine 330 remotely controls the LUUV 320 to install the buoy device 120 stowed within the underwater deployment device 210 at a particular location on the existing underwater cable 285 (refer to FIG. 2).

A third means for installation involves a submarine 330 launched human diver 340 installation. For this means, a human diver 340 along with the buoy device 120 stowed within the underwater deployment device 210 are launched from a submarine 330 underwater. The human diver 340 installs the buoy device 120 stowed within the underwater deployment device 210 at a particular location on the existing underwater cable 285 (refer to FIG. 2).

A fourth means for installation involves a submarine 330 launching a sled 350 with a human diver 360. For this means, a human diver 360 along with the buoy device 120 stowed within the underwater deployment device 210 are in a sled 350 that is launched from a submarine 330 underwater. The human diver 340 installs the buoy device 120 stowed within the underwater deployment device 210 at a particular location on the existing underwater cable 285 (refer to FIG. 2).

A fifth means for installation involves a fully automated LUUV 370 installation. For this means, a remotely operated LUUV 370 installs the buoy device 120 stowed within the underwater deployment device 210 at a particular location on the existing underwater cable 285 (refer to FIG. 2).

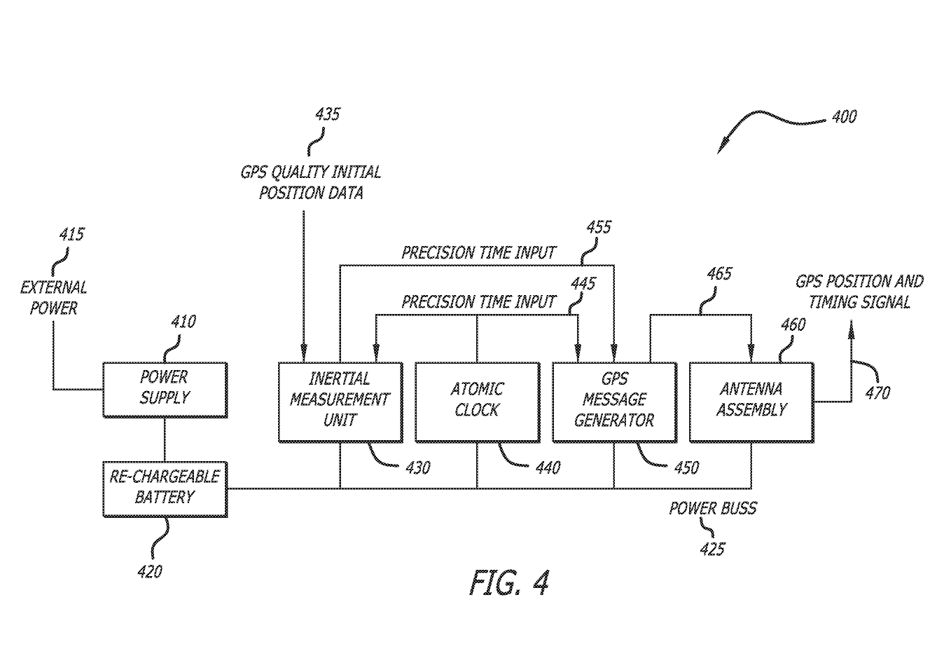

FIG. 4 is a block diagram 400 illustrating the disclosed system for re-establishing navigation links in a marine environment, in accordance with at least one embodiment of the present disclosure. In particular, this figure shows additional components that may be housed within the buoy device 120 (refer to FIG. 1A) to provide GPS signals and/or navigation timing signal restoration. When these components are housed within the buoy device 120, the buoy device 120 is able to communicate navigation signals (i.e. time synchronization signals), such as GPS signals as well as pseudo-GPS signals, which are generated by the buoy device 120 itself.

In this figure, a power supply 410 is shown to be connected to an external power source 415, which is used to power the power supply 410. The power supply 410 is also connected to a re-chargeable battery 420 so that the power supply 410 may re-charge the re-chargeable battery 420. The re-chargeable battery 420 along with an inertial measurement unit 430, an atomic clock 440, a GPS message generator, and an antenna assembly 460 (e.g., that may be housed within the antenna mast 105 of FIG. 1A) are all connected to a power buss 425. The atomic clock 440 generates a precision time 445 that is sent to the inertial measurement unit 430 and to the GPS message generator 450 for time synchronization.

The inertial measurement unit 460 may (or may not) receive GPS signals 435 containing GPS quality initial position data. The inertial measurement unit 460, of the buoy device may receive these GPS signals via the existing underwater cable 285 (refer to FIG. 2). In addition, the inertial measurement unit 460 also receives a precision time 445 from the atomic clock 440. The inertial measurement unit 460 may use the GPS signals 435 and the precision time 445 to generate an initial position of the buoy device 120 and/or to update (e.g., further refine) the position of the buoy device 120.

The inertial measurement unit 430 sends the initial position and/or the position updates 455 to the GPS message generator 450. The GPS message generator 450 codes the position information into a GPS signal (i.e. a GPS position and timing signal) for transmission. The GPS message generator 450 sends 465 the GPS signal to the antenna assembly 460 for transmission. The antenna assembly 460 transmits 470 the GPS signal (i.e. the GPS position and timing signal).

FIG. 5 is a diagram 500 illustrating an overview of the operation of the disclosed system for re-establishing communication, navigation, and power links in a marine environment, in accordance with at least one embodiment of the present disclosure. In this figure, three underwater deployment devices 210 are shown to be anchored to an existing underwater cable 285. The existing underwater cable 285 is connected to a land facility 510 (e.g., a control station that may, for example, provide global information grid (GIG) access). The land facility 510 sends communication signals, navigation signals, and/or power to the underwater deployment devices 210 via the existing underwater cable 285.

During operation, when there is a loss in communication and/or power, a deployment control signal, which may be sent by the land facility 510 via the existing underwater cable 285, is sent to at least one the underwater deployment device 210 to deploy at least one buoy device 120. In some embodiments, the deployment control signal is sent to the underwater deployment device 210 wirelessly. In this figure, the underwater deployment devices 210b and 210c are shown to have deployed buoy devices 120b and 120c, respectively. Buoy device 120b was deployed to be located just below the water's surface, while buoy device 120c was deployed to rise just above the water's surface. Also in this figure, a LUUV 520, after receiving a deployment control signal, is shown to have deployed a buoy device 120a, which was deployed to rise just above the water's surface.

After the buoy devices 120 are deployed, the land facility can transmit and/or receive at least one first linking signal (e.g., a communication signal, a navigation signal, and/or power signal) to the buoy device 120 via the existing underwater cable 285. In other embodiments, the first linking signal(s) is sent to the buoy device 120 wirelessly. In at least one embodiment, at least one first linking signal is a radio frequency (RF) signal, an infrared (IR) signal, an optical signal, and/or a power signal.

Then, the buoy device can transmit and/or receive at least one second linking signal (e.g., a communication signal, a navigation signal, and/or power signal) to the vehicle to re-establish at least one link. In one or more embodiments, at least one second linking signal is a radio frequency (RF) signal, an infrared (IR) signal, an optical signal, and/or a power signal. In some embodiments, at least one second linking signal is transmitted and/or received by the buoy device to the vehicle by a wire and/or wirelessly. In at least one embodiment, at least one link is a communication link, a time synchronization link, and/or a power link. In some embodiments, the time synchronization link is a global positioning system (GPS) link. In one or more embodiments, the vehicle a marine vehicle, an airborne vehicle, or a terrestrial vehicle.

Also in this figure, the buoy device 120a is shown to be re-establishing at least one link with a ship 530a. In addition, buoy device 120b is shown to be re-establishing at least one link with a plane 540b, and buoy device 120c is also shown to be re-establishing at least one link with two planes 540d and 540e.

Plane 540a is shown to be communicating via crosslink with ship 530b, which is communicating via crosslink with plane 540b and 540c. Planes 540b and 540c are communicating with each other via a crosslink. In addition, plane 540d is communicating via crosslink with satellite 550, which is communicating with the land facility 510.

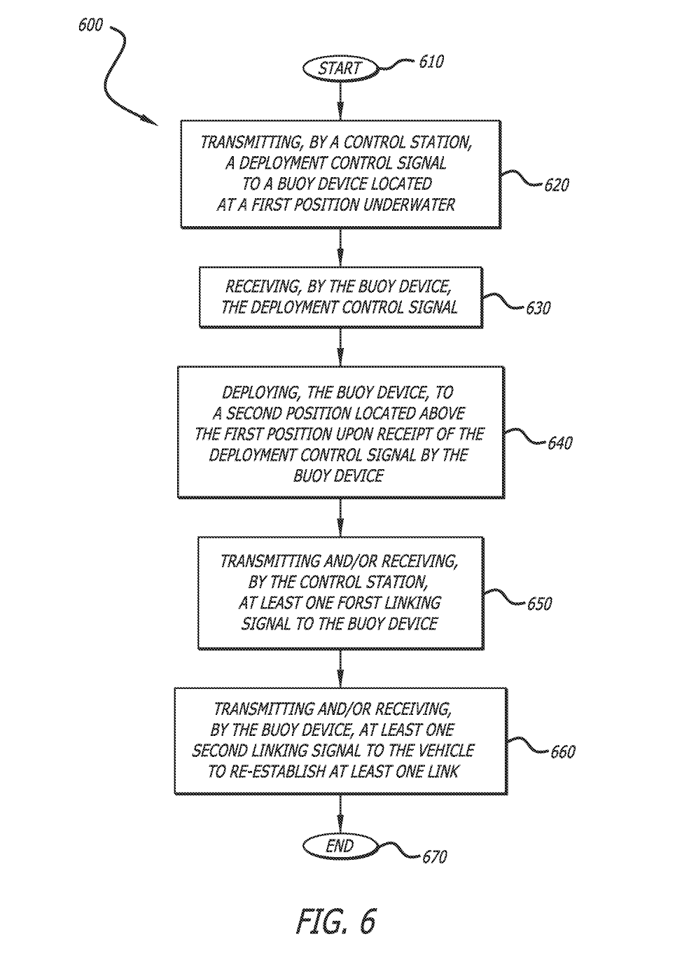

FIG. 6 depicts a flow chart depicting the disclosed method 600 for re-establishing communication, navigation, and power links in a marine environment, in accordance with at least one embodiment of the present disclosure. At the start 610 of the method 600, a control station transmits a deployment control signal to a buoy device located at a first position underwater 620. Then, the buoy device receives the deployment control signal 630. The buoy device then deploys to a second position, located above the first position, upon receipt of the deployment signal 640. The control station transmits and/or receives at least one first linking signal to the buoy device 650. The buoy device transmits and/or receives at least one second linking signal to a vehicle to re-establish at least one link 660. Then, the method 600 ends 670.

Although particular embodiments have been shown and described, it should be understood that the above discussion is not intended to limit the scope of these embodiments. While embodiments and variations of the many aspects of the present disclosure have been disclosed and described herein, such disclosure is provided for purposes of explanation and illustration only. Thus, various changes and modifications may be made without departing from the scope of the claims.

Where methods described above indicate certain events occurring in certain order, those of ordinary skill in the art having the benefit of this disclosure would recognize that the ordering may be modified and that such modifications are in accordance with the variations of the present disclosure. Additionally, parts of methods may be performed concurrently in a parallel process when possible, as well as performed sequentially. In addition, more parts or less part of the methods may be performed.

Accordingly, embodiments are intended to exemplify alternatives, modifications, and equivalents that may fall within the scope of the claims.

Although certain illustrative embodiments and methods have been disclosed herein, it can be apparent from the foregoing disclosure to those skilled in the art that variations and modifications of such embodiments and methods can be made without departing from the true spirit and scope of the art disclosed. Many other examples of the art disclosed exist, each differing from others in matters of detail only. Accordingly, it is intended that the art disclosed shall be limited only to the extent required by the appended claims and the rules and principles of applicable law.

We claim:

1. A method for re-establishing at least one link to a vehicle, the method comprising:
transmitting, by a control station, a deployment control signal to a deployment device located underwater;
receiving, by the deployment device, the deployment control signal;
deploying, by the deployment device, a buoy device from a first position to a second position located above the first position upon receipt of the deployment control signal by the deployment device;
at least one of transmitting and receiving, by the control station, at least one first linking signal to the buoy device; and
at least one of transmitting and receiving, by the buoy device, at least one second linking signal to the vehicle to re-establish the at least one link.

2. The method of claim 1, wherein the deployment control signal is transmitted by at least one of a wire and wirelessly.

3. The method of claim 1, wherein the second position is located at least one of underwater and above water.

4. The method of claim 1, wherein the vehicle is one of a marine vehicle, an airborne vehicle, and a terrestrial vehicle.

5. The method of claim 1, wherein the at least one first linking signal is at least one of a radio frequency (RF) signal, an infrared (IR) signal, an optical signal, and a power signal.

6. The method of claim 1, wherein the at least one second linking signal is at least one of a radio frequency (RF) signal, an infrared (IR) signal, an optical signal, and a power signal.

7. The method of claim 1, wherein the at least one first linking signal is at least one of transmitted and received by the control station by at least one of a wire and wirelessly.

8. The method of claim 1, wherein the at least one second linking signal is at least one of transmitted and received by the buoy device by at least one of a wire and wirelessly.

9. The method of claim 1, wherein the at least one link is at least one of a communication link, a time synchronization link, and a power link.

10. The method of claim 9, wherein the time synchronization link is a global positioning system (GPS) link.

11. The method of claim 1, wherein the method further comprises activating, by the buoy device, at least one locator indicator.

12. The method of claim 11, wherein the at least one locator indicator is at least one of a visual indicator, an audio indicator, and a communication signal indicator.

13. A system for re-establishing at least one link to a vehicle, the system comprising:
a control station to transmit a deployment control signal to a deployment device located underwater, and to at least one of transmit and receive at least one first linking signal to a buoy device;
the deployment device to receive the deployment control signal, and to deploy the buoy device from a first position to a second position located above the first position upon receipt of the deployment control signal by the deployment device,
the buoy device to at least one of transmit and receive at least one second linking signal to the vehicle to re-establish the at least one link.

14. The system of claim 13, wherein the deployment control signal is transmitted by at least one of a wire and wirelessly.

15. The system of claim 13, wherein the second position is located at least one of underwater and above water.

16. The system of claim 13, wherein the vehicle is one of a marine vehicle, an airborne vehicle, and a terrestrial vehicle.

17. The system of claim 13, wherein the at least one first linking signal is at least one of a radio frequency (RF) signal, an infrared (IR) signal, an optical signal, and a power signal.

18. The system of claim 13, wherein the at least one second linking signal is at least one of a radio frequency (RF) signal, an infrared (IR) signal, an optical signal, and a power signal.

19. The system of claim 13, wherein the at least one first linking signal is at least one of transmitted and received by the control station by at least one of a wire and wirelessly.

20. An apparatus for re-establishing at least one link to a vehicle, the apparatus comprising:
a buoy device comprising at least one antenna,
wherein the buoy device is to deploy from a first position underwater to a second position located above the first position, and to at least one of transmit and receive at least one linking signal to the vehicle to re-establish the at least one link.
